(19) United States
(12) Patent Application Publication
(10) Pub. No.: US 2003/0066078 A1
(43) Pub. Date: Apr. 3, 2003

(54) Subscriber interface device for use with an intelligent content-broadcast network and method of operating the same

(75) Inventors: Stephen Bjorgan, San Francisco, CA (US); Robert Noakes, Walnut Creek, CA (US)

Correspondence Address: DAVIS MUNCK, 900 THREE GALLERIA TOWER, 13155 NOEL ROAD, DALLAS, TX, 75240, US

(73) Assignee: FRANCE TELECOM RESEARCH AND DEVELOPMENT L.L.C., Brisbane, CA

(21) Appl. No.: 10/126,502

(22) Filed: Apr. 19, 2002

Related U.S. Application Data
(60) Provisional application No. 60/285,392, filed on Apr. 20, 2001.

(51) Int. Cl. H04N 7/025

(52) U.S. Cl. 725/34

(57) ABSTRACT

An interface device and method for use with an intelligent content-broadcast network. User profile information is collected and stored in a memory device assessable to a secondary content processor. Secondary content is information, such as advertisements from a television network source, that is available for insertion into the primary broadcast stream as appropriate. When a particular user is identified as viewing a primary-content program, a processor associates the user with a stored profile and uses the profile information to determine what, if any, secondary content should be inserted and thus presented to the user as if it had been a part of the broadcast stream. The portion of the primary broadcast stream where secondary content may be inserted is indicated by embedded cues.

### PRIORITY CLAIM TO PROVISIONAL PATENT APPLICATION

The present invention claims priority to U.S. Provisional Application Serial No. 60/285,392 filed on Apr. 20, 2001. The disclosures of this related provisional patent application is incorporated herein by reference for all purposes as if fully set forth herein.

### CROSS REFERENCE TO RELATED PATENT DOCUMENTS

The present invention is related to that disclosed in U.S. patent application Ser. No. ______ and ______ (Atty. Docket No. FRAN01-00003), filed concurrently herewith on Apr. 19, 2002, entitled “SYSTEMS FOR SELECTIVELY ASSOCIATING CUES WITH STORED VIDEO FRAMES AND METHODS OF OPERATING THE SAME”, which is assigned to the assignee of the present invention. The disclosure of this related patent application is incorporated herein by reference for all purposes as if fully set forth herein.

### TECHNICAL FIELD OF THE INVENTION

The present invention is directed, in general, to mix Internet/broadcast systems and, more specifically, to a device for subscriber use in selectively interfacing with system platforms for associating cues with stored video frames.

### BACKGROUND OF THE INVENTION

In conventional television (“TV”) systems, television commercials may be inserted into a video program stream at a television broadcast facility. The video program stream, including the inserted commercials, is then transmitted wirelessly or by a cable system to all television receivers within range of the station. However, inserting commercials at a particular broadcast facility has certain drawbacks. Some very large television stations that are centered in certain home markets, such as New York, Chicago, or Atlanta, are also available in other cities outside the home markets. However, those video streams broadcast from those stations contain local advertising specific to the home market. This advertising is of little value outside the home market.

There are well-known video processing systems that replace an original commercial advertisement in a broadcast television signal with a substitute commercial advertisement. The substitute commercial is targeted to a specific demographic group that is likely to find the substitute commercial of greater value the original commercial advertisement. The replacement can be done at various points of the delivery chain, for example, at local affiliates of a network.

There are other reasons for replacing commercials in a video stream. One primary reason is the rebroadcast of television programs containing dated commercials. Many commercials are of a time-limited nature. A commercial advertisement for the 2001 World Series that occurs during a television situation comedy (or sitcom) is of little value if the sitcom is rebroadcast in 2002, 2003, or later. Similarly, a commercial may announce that a product is offered for sale at particular price in 2001. This price is unlikely to be valid in subsequent years. Moreover, when the commercial is rebroadcast, the product may no longer in production or the manufacturer may no longer be in business, or both. Even in the short run, a commercial that is tied to a particular event is of little value after the event has occurred. Hence, commercials for Mother's Day sales and Christmas sales are of no value the day after Mother's Day and Christmas, respectively.

This time-limited nature of commercials is a particularly important drawback with respect to home recording of television programs. A viewer may use a video-cassette recorder (VCR) or a video disk recorder (VDR) to record a broadcast television program that the viewer views at a later time. This time-shifted viewing provides great convenience to consumers, but often renders recorded commercials useless. If a viewer records a television program the week before Thanksgiving and watches it the week after Thanksgiving, all recorded commercials related to Thanksgiving, including sales offers that expire on Thanksgiving, are essentially useless.

Moreover, commercials are often, if not usually, directed to a particular type of audience. While some may have universal appeal, more frequently both the type of product being advertised, and the way in which the message is conveyed, are calculated to resonate with a particular demographic group. Beer and wine commercials, for example, are targeted at an audience old enough to enjoy these products, while advertisements for toys and games are often designed to appeal to young viewers. Fast-food restaurants may want to appeal to both groups but use different messages for doing so. For example, young purchasers may be attracted by exciting, fast-moving offers of free toys accompanied by a modern music medley, while an appeal to their parents might include a thoughtful demonstration of the healthy food choices that are available at the restaurant, perhaps with nature sounds audible in the background. Audience targeting, of course, can currently be performed by matching, as closely as possible, the types of commercials with the types of programs they accompany. But predicting the demographic profile of the viewers of a certain program and what ads will appeal to them can sometimes be difficult, at least until a good deal of historical evidence has been gathered. And the time-shifting phenomenon, described above, may not only result in anachronous commercial messages, but may also result in a viewing audience that is different from one originally predicted.

People vary too, of course, and often have needs and interests that are not normally associated with the demographic profile into which they happen to fall. Such an audience may be particularly difficult to target, since there are few accurate ways, if any, to predict their viewing habits or the type of advertising that will appeal to them.

Therefore, there exists a need in the art for improved video processing systems that enable providers of broadcast video and other programming to more accurately target secondary content toward the current needs of the specific audience viewing their primary content programming at any given time.

### SUMMARY OF THE INVENTION

To address the above-discussed deficiencies of the prior art, it is a primary object of the present invention to provide, for use in a digital broadcast environment, a device for interfacing with systems and system platforms for cueing and intelligently inserting content data into a digital content stream comprising video track data, audio track data and content descriptor data, and methods of operating the same.

According to an advantageous embodiment of one invention hereof, intelligent systems are provided for inserting cues into the broadcast content stream. One important aspect of this embodiment is the use of a cue to insert “secondary” content into a “primary” content stream. There is disclosed a device for interfacing with systems and system platforms for selectively associating cues with stored video frames according to a user profile compiled for this purpose. According to one embodiment, an exemplary video processing system comprises a video recording system and a video playback system that can also select alternate secondary content based on a stored user profile.

The video recording system is capable of (i) receiving a digital content stream comprising video track data, audio track data and content descriptor data and (ii) storing the video track data as video frames in a storage device. The video recording system comprises a commercial detection controller operable, in response to the received content descriptor data, to (i) detect a subset of the video frames associated with a commercial in the received digital content stream, and (ii) associate a cue with at least one of the subset of the video frames.

The video playback system is capable of playing back the stored video track data, and comprises a video playback controller operable to detect cues associated with ones of the subsets of the video frames and to direct the video playback system in response thereto to selectively replace the commercial with a substitute commercial during playback based on the stored user profile or profiles associated with the viewers that are present at that particular time.

Embedding cues in digital content, or media streams facilitates the creation of applications that are capable of receiving and processing one or more digital content streams. Controllers implementing these media processing applications may suitably be implemented at a video processing system (e.g., television, set top box, video cassette recorder, video storage system, etc.), or at a network intermediary (e.g., gateway, proxy, etc.).

Exemplary “cues,” as the term is broadly used herein are machine-readable binary codes. Preferably, the cues are variable in size, format and density of information provided, and may suitably be used to formed a matrix of at least one dimension having data contained therein. An important aspect of alternate embodiments hereof is that the format of a given cue as well as the position of insertion into a content stream may suitably be based upon the particular application being executed. Stated differently, a cue may be any suitably arranged binary code that is in the form of a data packet or a portion thereof (e.g., header-based, data-based, etc.).

Another important aspect of this invention is the use of a cue to selectively replace a commercial within a subset of the video frames with a substitute commercial during playback. This may suitably be to replace an “expired” commercial or, alternatively, to present a “targeted” commercial, such targeting possibly based, at least in part, upon the economic characteristics of a particular geographic location, possibly identified by zip code, though other measurable characteristics concerning the viewing/listening audience, including demographics data (e.g., age, sex, income, etc.), usage patterns, dynamic and/or static profiles, purchase history and the like, all of which are within the scope of this invention.

User profiles, that is, any system-stored data relating to the audience that is or is likely to be viewing or listening at a given time, may be stored at any one or more of several system components, including a remote control, a set top box, a personal digital assistant (PDA), or in a control data base accessible through an electronic communications netware.

The foregoing has outlined rather broadly the features and technical advantages of the present inventions so that those skilled in the art may better understand the detailed description that follows. Additional features and advantages of the inventions will be described hereinafter. Those skilled in the art should appreciate that they may readily use the conception and the specific embodiment disclosed as a basis for modifying or designing other structures for carrying out the same purposes of the present inventions. Those skilled in the art should also realize that such equivalent constructions do not depart from the spirit and scope of the invention in its broadest form.

Before undertaking the detailed description, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” and “processor” mean any device, system or part thereof that controls at least one operation, such a device may be implemented in hardware, firmware or software, or some combination of at least two of the same. It should be noted that the functionality associated with any particular controller/processor may be centralized or distributed, whether locally or remotely. In particular, a controller/processor may comprise one or more data processors, and associated input/output devices and memory, which execute one or more application programs or an operating system program. Definitions for certain words and phrases are provided throughout this patent document, those of ordinary skill in the art should understand that in many, if not most instances, such definitions apply to prior, as well as future uses of such defined words and phrases.

### BRIEF DESCRIPTION

For a more complete understanding of the present inventions, and the advantages thereof, reference is now made to the following descriptions taken in conjunction with the accompanying drawings, wherein like numbers designate like objects, and in which:

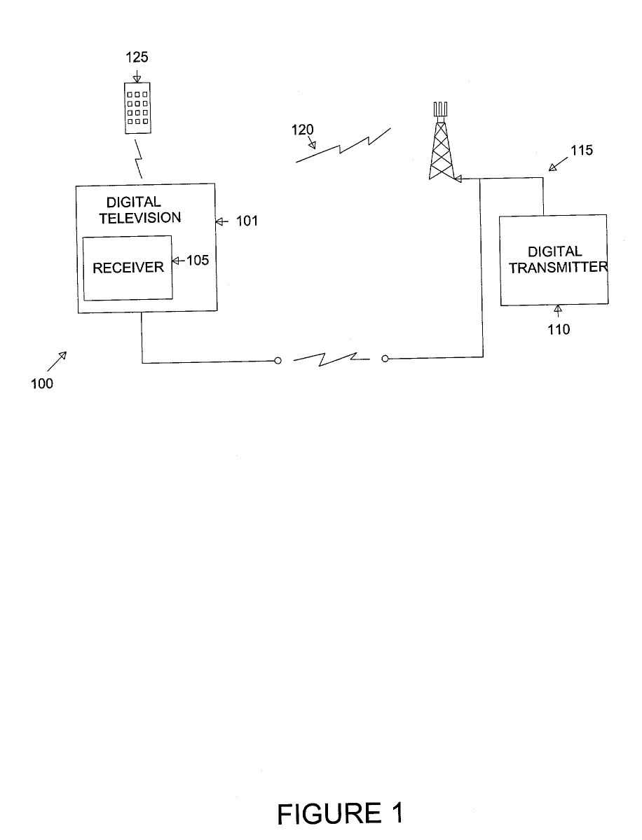

FIG. 1 illustrates a conceptual block diagram of a digital television system according to one embodiment of the present invention;

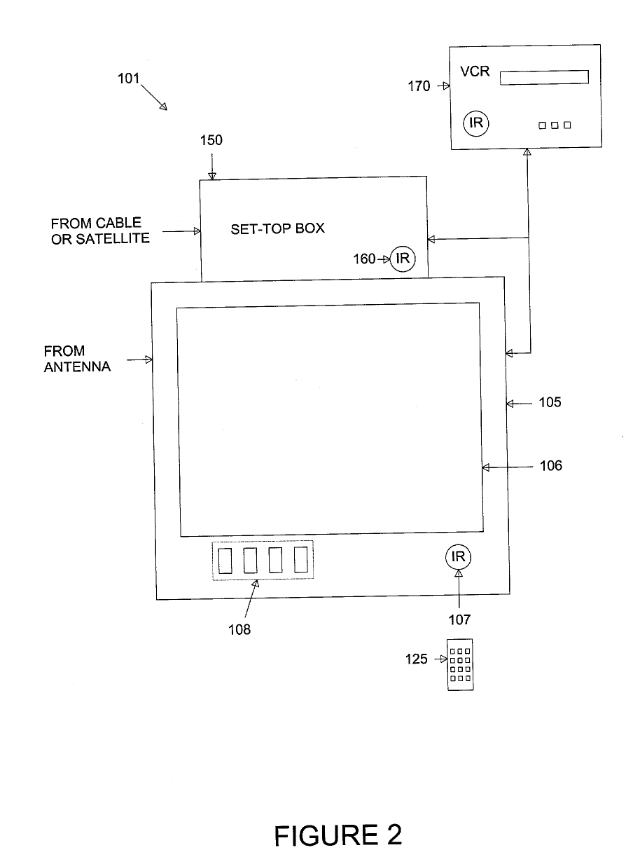

FIG. 2 illustrates in more detail the components of the exemplary digital television system of FIG. 1 that are normally located at the viewing site.

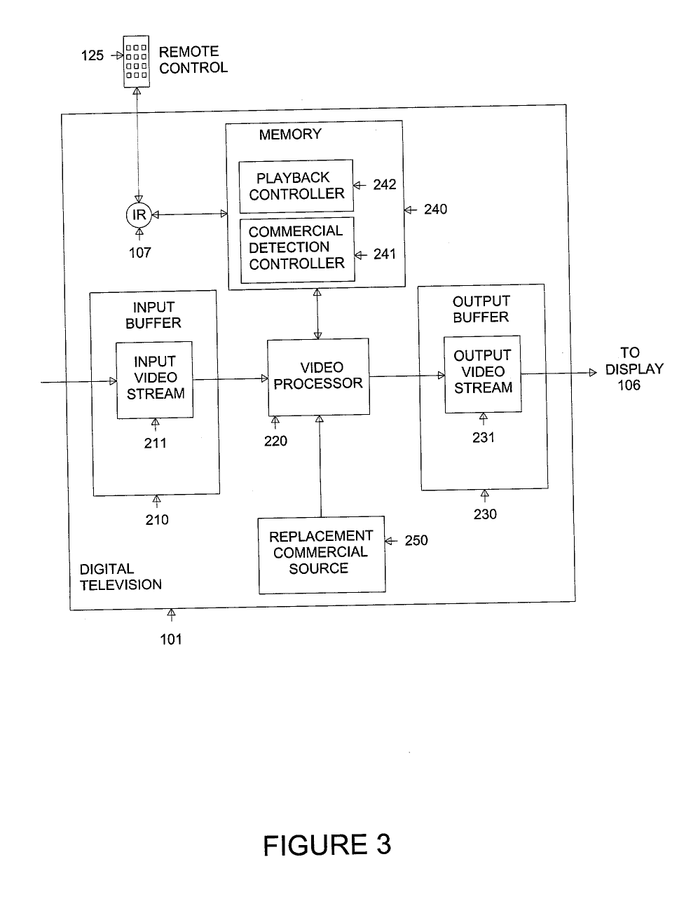

FIG. 3 illustrates in greater detail selected portions of digital system 100 according to the embodiments of FIGS. 1 and 2.

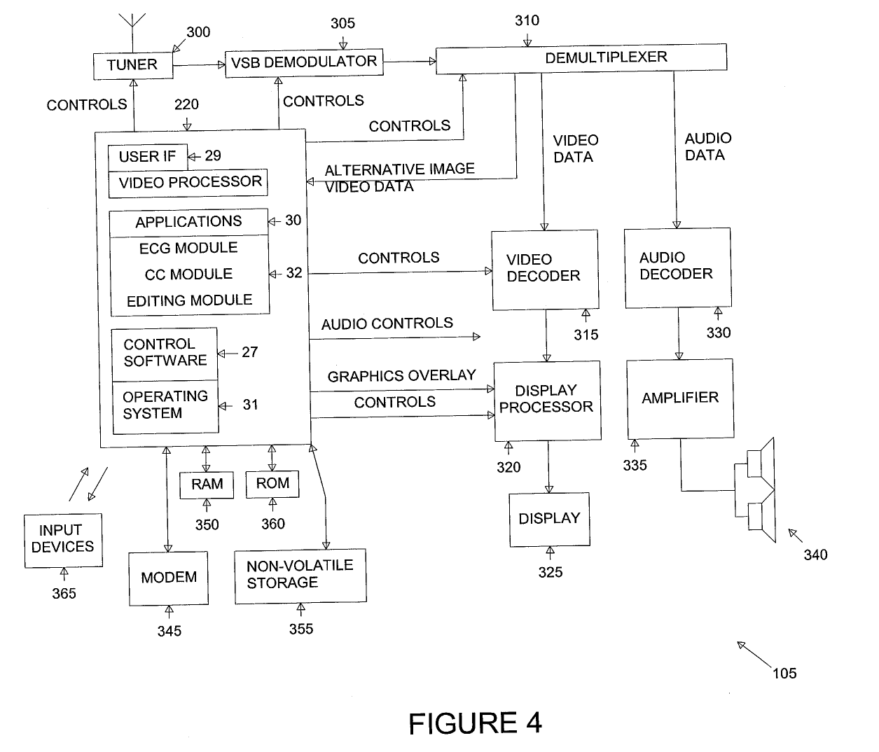

FIG. 4 illustrates a block diagram of a digital television receiver according to the embodiment of FIGS. 1 to 3;

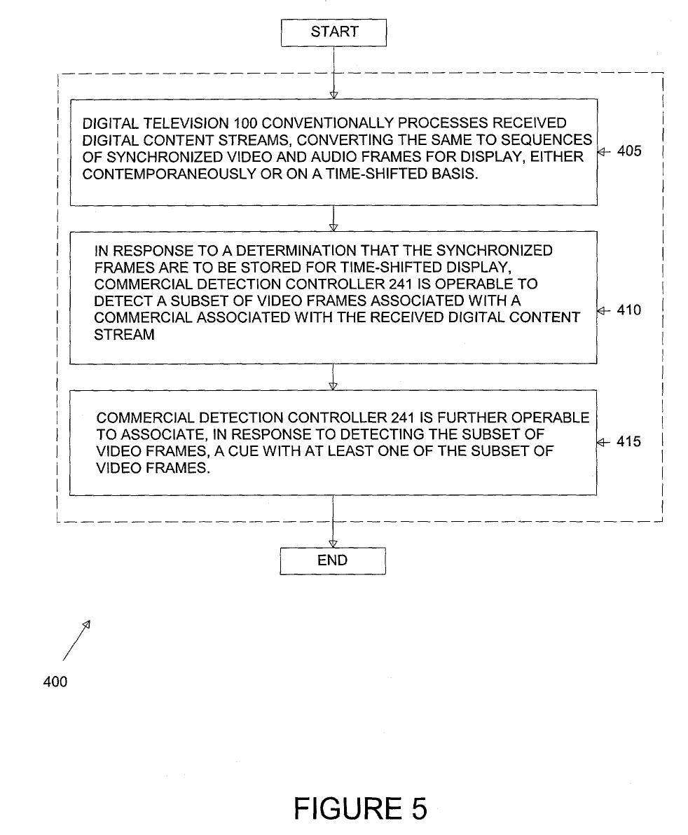

FIG. 5 illustrates a flow diagram of an exemplary method of operating the digital television according to the embodiment of FIGS. 1 to 4; and

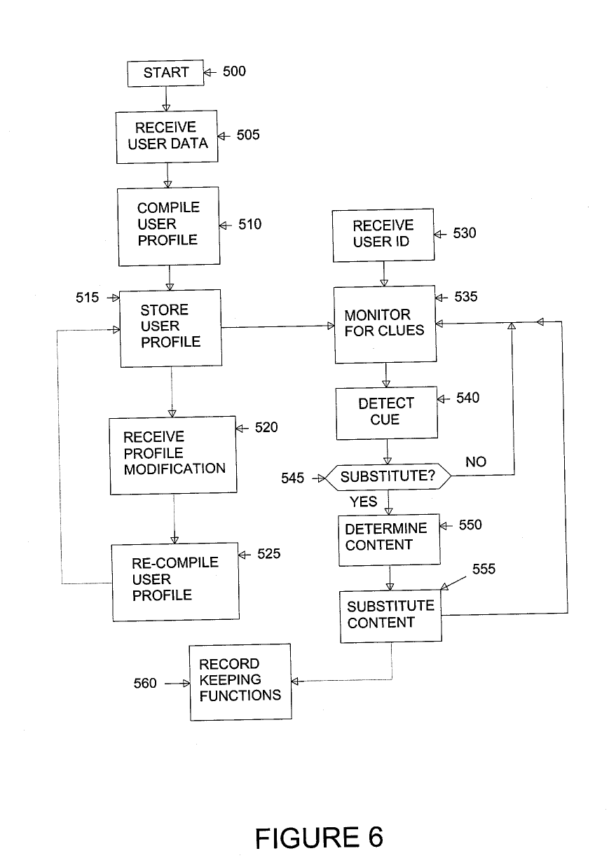

FIG. 6 illustrates a flow diagram of an exemplary method of creating and applying a user profile according to an embodiment of the present invention.

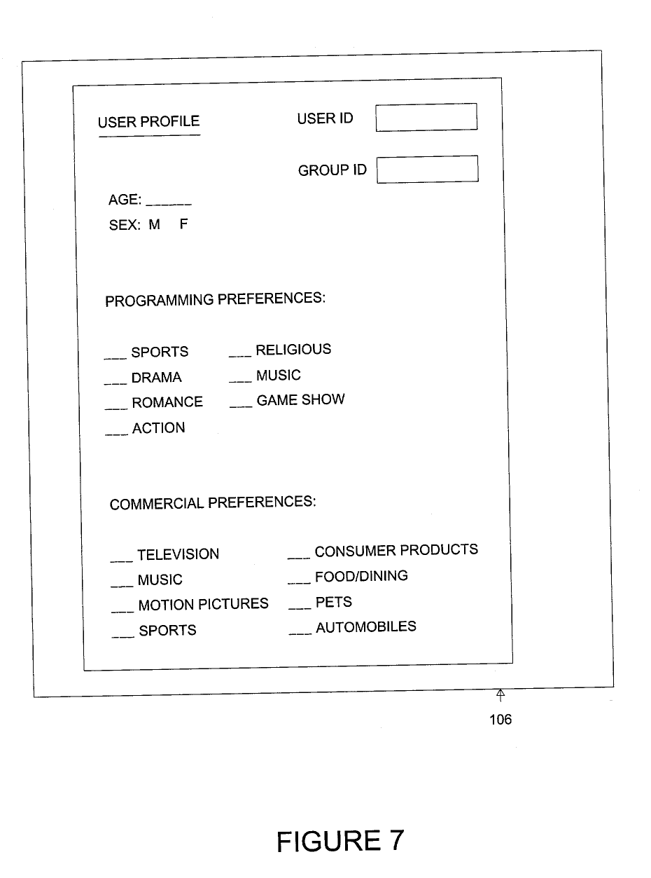

FIG. 7 is an example of a graphically displayed user profile such as one that might be viewed on a display, and that can be used by a viewer to enter or modify user profile information.

### DETAILED DESCRIPTION

FIGS. 1 through 7, discussed below, and the various embodiments used to describe the principles of the present inventions in this patent document are by way of illustration only and should not be construed in any way to limit the scope of the inventions set forth herein. Those skilled in the art will understand that the principles of the present inventions may be implemented in any suitably arranged content broadcast system, including for instance, television, digital cinema, and radio.

Note that for convenience, the term “primary content” is frequently used herein to describe the programming, such as video programming, that the audience is actively watching or listening to, while “secondary content” is frequently used to designate broadcast information that is simply included along with the primary content, such as television commercials. As is generally understood, this type of secondary content is often inserted on behalf of sponsors; that is, entities paying the broadcaster for this service. It should be apparent to one skilled in the art, however, that secondary broadcast content, that is, content that can be inserted into a primary broadcast stream at places indicated by embedded cues, has other uses as well. Therefore, the terms are not intended to be limited to only the types of content referred to in describing exemplary embodiments.

FIG. 1 illustrates a conceptual block diagram showing selected components of a digital television system (generally designated 100) according to one embodiment of the present invention. Note that the terms ‘television’ and ‘TV’, as used herein, are intended to include both conventional home television, which provides a convenient example, and the many variations thereof such as High-Definition TV (HDTV) and Internet-transported streaming video. And while such devices are often used for entertainment purposes, they may also serve other functions such as providing educational training material to an audience through either a public or a private network. Digital television system 100 is an exemplary video processing system in accordance with the principles of the present invention. Digital television system 100 illustratively includes a digital television 101, a digital receiver 105, a transmitter 110, a transmission medium 115, and a remote interface device 125.

Exemplary transmission medium 115 may suitably be a coaxial cable, fiber-optic cable, or the like, over which digital content streams may be transmitted by transmitter 110 to receivers such as digital receiver 105. Transmission medium 115 may include a radio frequency (“RF”) link between at least portions thereof, for instance, content data may be transmitted between transmitter 110 and digital receiver 105 via an RF link, such as RF link 120. Exemplary digital content streams comprise video track data, audio track data and content descriptor data. Transmitter 110 may suitably be located at a centralized broadcast facility, such as a television station or studio, from which the digital content streams may be transmitted to digital television receivers. “Broadcast”, as used herein, refers to both public and private broadcasts. “Content” refers to the information transmitted for viewing or listening, and except where explicitly stated otherwise, includes both the electrical signals used for transmission and the actual audio-visual information as perceived by the viewing audience. An “intelligent content-broadcast network” is one that broadcasts a plurality of content types, such as the primary and secondary content referred to herein, and delineates them (for example, by embedded cues) so that a broadcast receiver can manipulate the content stream, for example by substituting alternative secondary content so that current commercials are displayed during the playback of a pre-recorded program.

FIG. 2 illustrates in more detail the components of exemplary digital television system 100 that are more normally located at the viewing site, such as one that may be used in practicing an embodiment of the present invention. Exemplary television 101 comprises television (TV) receiver 105, set top box 150 with infrared (IR) detector 160, video-cassette recorder (VCR) 170, video display screen 106, and remote control 125.

As shown in FIG. 2, television receiver 105 comprises video display screen 106 for displaying television programs, infrared (IR) sensor 107, and a set of manual controls 108, as indicated by a surrounding dotted line. Manual controls 108 may include, without limitation, a power button, a volume control button, vertical and horizontal control buttons and one or more channel selection buttons. Infrared (IR) sensor 107 receives IR control signals from hand-held remote control unit 125 that is operated by the television viewer. Typically, IR control signals from remote control unit 125 that are detected by IR sensor 107 are processed within television receiver 105 in order to change the channel being viewed on video display screen 106, to increase or to decrease the volume, to turn television receiver 105 on and off, and the like. Optionally, the IR control signals detected by IR sensor 107 may be relayed to set top box 150 or VCR 170 in order to control their operation. Set top box 150 performs conventional tuning and demodulation of incoming signals from a cable or satellite television program service provider to produce, for example, a Stream of Moving Picture Experts Group (MPEG) encoded digital data from which video signals may be derived.

In an illustrative embodiment, the video and audio track data are encoded, preferably at the centralized broadcast facility, prior to transmission. For instance, the audio track data may be encoded in AC3 format and the video track data may be encoded in Motion Picture Experts Group (“MPEG”) coding, and, in particular, MPEG-2 or higher format.

Exemplary video track data comprises a video sequence that, for instance, may include one or more television programs and television advertising (i.e., commercials) that are associated with the television programs. Exemplary audio track data comprises sound associated with corresponding portions of the video track data.

Alternatively, television receiver 105 may directly receive an incoming television broadcast signal from an external antenna (not shown). In this alternative embodiment of the invention, television receiver 105 performs conventional tuning and demodulation of incoming RF signals received from the antenna to produce, for example, a stream of MPEG encoded digital data from which video signals may be derived.

FIG. 3 schematically illustrates selected portions of the digital video processing system of digital television 101, according to the embodiments of FIGS. 1 and 2. Digital television 101 illustratively comprises input buffer 210, video processor 220, output buffer 230, memory 240, and replacement commercial source 250. Note that in an alternate embodiment, replacement commercial source 250 may actually reside in a component other than digital television 101.

According to this embodiment, input buffer 210, video processor 220, output buffer 230, memory 240, and replacement commercial source 250 cooperate to provide a video recording system in accord with the principles of the present invention. The video recording system is operable to (i) receive digital content streams comprising video track data, audio track data and content descriptor data, (ii) conventionally process the same in video processor 220 to convert (e.g., decode, decompress, translate, etc.) the same to a sequence of synchronized video and audio frames for display, and (iii) display the same to a display device using output buffer 230 as temporary storage or, alternatively, store such processed sequences of video/audio frames in a storage device, such as memory 240, for time shift display.

Memory 240 stores commercial detection controller 241, which is executable by video processor 220. Exemplary commercial detection controller 241 contains, among other things, the code for controlling the interactive cooperation between a main content source and a plurality of secondary content sources. According to an advantageous embodiment of the present invention, memory 340 may comprise a removable media drive, such as a CD-ROM drive and commercial detection controller 241 may be instantiated from a removable media disk.

In the event that processed sequences of video/audio frames are to be stored for time shift display, commercial detection controller 241 is operable, in response to received content descriptor data associated therewith, to (i) detect subsets of the audio or video frames associated with a commercial within the received digital content stream, and (ii) selectively associate one or more cues with at least one of the audio or video frames of the subset of the same. In accordance herewith, the cue operable is operable to cause a playback controller 242 (also illustratively stored in memory 240) to selectively replace the commercial with a substitute commercial during playback of the stored video track data. It is important to note that video processor 220, depending upon its implementation, may suitably convert the digital content streams a sequence of synchronized analog video and audio frames, thereby forming an analog content stream.

Again, cues may include clocking data associated with the commercial and, according to one advantageous embodiment, the clocking data includes at least one of either the start time of the commercial or the duration time of the commercial. Cues may also include at least one of either content indicia associated with the received digital content stream or a subscriber (user) profile.

In playback mode, exemplary playback controller 242 directs video processor 220 to retrieve the stored sequences of video/audio frames that may suitably include one or more associated cues and to store the same in output buffer 230. More particularly, operating under the control of playback controller 242, video processor 220 retrieves each frame from memory 240 and parses each of the same for associated cues. Upon detection of a cue, playback controller 242 processes the same to determine whether any frames associated with a commercial should be replaced, to thereby selectively replace certain commercials with substitute commercials during playback. Selection of substitute commercials (or other secondary content) takes into account user profiles (described in more detail below) defining certain characteristics of the current audience. The user profiles may be stored in memory 240, or in a user interface device such as remote control 125. When stored in memory 240, remote device 125 is used simply to indicate to playback controller 242 the identity of current audience members, so that their profiles can be found or solicited.

According to this embodiment, such substitute commercials are illustratively provided through replacement commercial source 250. Of course, in alternate embodiments, replacement commercial source 250 may comprise any known storage device, including a hard disk drive, CD-ROM drive, and DVD drive, a VCR tape, or a network feed over which another incoming digital content stream is being received.

Examples of applications that may suitably be eased by the embedding of cues include advertising, recording, insertion, switching, adaptation and the like. Such applications typically require relatively exact time synchronization with arriving media packets to operate correctly. Failure to maintain precise time synchronization (e.g., say when switching between two or more source streams) may result in undesired perceptible artifacts when the resulting stream is rendered. Such time synchronization between applications and media streams is also required in implementations where relatively little media packet buffering is available at a stream processing point; for example, in wireless devices and Internet appliances.

Note that while it is considered advantageous to substitute current secondary content into cued portions of the primary content stream, it is not necessary in practicing the present invention to do so universally. In fact, in some cases it may be desirable to use “dated” cues that indicate secondary content that should not be replaced until after a specified date. In another embodiment, the cues may include a priority indicator so that the original secondary content is not replaced by new content designated with a lower priority level. And some commercial messages may not be delineated with cues, or use cues that indicate no other content may be substituted, or in another embodiment, not substituted unless a certain authorization key can be supplied.

The cueing methodology of the present invention may also be used to insert advertisements, messages, user queries, alternate content and the like at discreet positions within broadcast programming (e.g., radio, television, etc.), wherein programming may suitably be live, time-shifted or some suitable combination thereof. Further discussion of these extended inventions are disclosed in related U.S. patent application Ser. No. ______ (Atty. Docket No. FRAN01-00003).

FIG. 4 illustrates a detailed block diagram of video digital receiver 105, according to the embodiments of FIGS. 1 to 3. Exemplary digital receiver 105 illustratively includes a tuner 300, a VSB demodulator 305, a demultiplexer 310, a video decoder 315, a display processor 320, a display screen 325, an audio decoder 330, an amplifier 335, speakers 340, video processor 220, a modem 345, a random access memory (“RAM”) 350, a non-volatile storage 355, and a read-only memory (“ROM”) 360. Each of the foregoing features of digital receiver 105 is known in the art; however, descriptions are here provided in the interest of completeness.

Tuner 300 comprises a standard analog RF receiving device capable of receiving an analog signal that includes analog video and audio data. Tuner 300 may receive this signal from either transmission medium 115 or via RF link 120 over a particular frequency channel. Demodulator 305 receives the input analog signal from tuner 300 and, based on control signals received from the video processor 220, converts the analog signal into digital data packets. These data packets are then output to demultiplexer 310. Demultiplexer 310 receives the data packets output from demodulator 305 and “desamples” the same, meaning that the packets are output either to video decoder 315, the audio decoder 330, or video processor 220 depending upon an identified packet type.

Video processor 220 identifies whether data packets from the demultiplexer 310 include video track data, audio track data, or content descriptor data, and causes the data packets to be output accordingly.

Stated differently, video data is output to video decoder 315, audio data is output to audio decoder 330, and content descriptor data are output to the video processor 220. In an alternative embodiment, the data packets are output from the demodulator 305 directly to video processor 220. According to the same, video processor 220 performs the tasks of the demultiplexer 310. Specifically, in this embodiment, video processor 220, receives the data packets, desamples the data packets, and then outputs the data packets based on the type of data stored therein. In this embodiment, however, video processor 220 retains the content descriptor data.

The video decoder 315 decodes video data packets received from the demultiplexer 310 (or from video processor 220) in accordance with control signals, such as timing signals and the like, received from video processor 220. In an advantageous embodiment, the video decoder 315 is an MPEG-2 decoder; however, any decoder may be used so long as it is compatible with the type of coding used to code the video data. The decoded video data may then transmitted to display processor 320, or, if time shifted play back is intended, stored to memory 240, as described hereinabove.

Display processor 320 forms images from video data and outputs those images to display screen 325. In operation, display processor 320 outputs a video sequence in accordance with control signals received from video processor 220 based on the decoded video data received from video decoder 315 and based on graphics data received from video processor 220. More specifically, display processor 320 forms images from the decoded video data received from video decoder 315 and from any graphics data received from video processor 220, and inserts the images formed from the graphics data at appropriate points in the video sequence defined by the images formed from the decoded video data.

Display processor 320 may also be used to create a graphical display that incorporates user-profile information into a visual form for manual creation, review, and modification by a user. This graphical display may be set appear automatically whenever a new, unknown user is encountered.

Audio decoder 330 is used to decode audio track data associated with video track data displayed on display screen 325. In preferred embodiments of the invention, the audio decoder 330 comprises an AC3 audio decoder; however, other types of audio decoders may be used in conjunction with the present invention depending, of course, on the type of coding used to code the audio data. Audio decoder 330 operates in accordance with audio control signals received from video processor 220. These audio control signals include timing information and the like, and may include information for selectively outputting the audio data. Output from the audio decoder 330 is provided to the amplifier 335. The amplifier 335 comprises a conventional audio amplifier that adjusts an output audio signal in accordance with audio control signals relating to volume or the like input via the input devices 365. Audio signals adjusted in this manner are then output via the speakers 340.

Video processor 220 is capable of executing stored program instructions to control operations of digital receiver 105. These program instructions comprise parts of software modules (not shown) that are stored in either an internal memory of video processor 220 or in RAM 350 or ROM 360. These software modules may be updated via the modem 345 and/or via the MPEG-2 bit stream. Stated differently, video processor 220 receives data from the modem 345 or via the bit stream that may include software module updates, video data (e.g., graphics data or the like), audio data, and a user profile.

A “user profile” comprises information relating to one or more broadcast content viewers, or potential viewers, and is used in selecting an alternate secondary content stream. The user profile may be stored anywhere within digital receiver 105, but, in alternate embodiments, the user profile may be stored in non-volatile storage 355 or in input devices 365. User profiles may, of course, be implemented in static or dynamic memory. And there is no requirement that the user profile be maintained or stored in only a single location.

The user profile may correspond to a single user or, quite literally, to a family of users. For example, each person living at a particular residence may be a member of the residence user profile. A residence user profile may be a simple collection of individual user profiles, or it may combine those profiles to form a single residence profile. In this way, the alternate as secondary content stream may be tailored more accurately to the particular audience viewing a program at any given time. This means the same program may have one set of promotional materials if viewed by the adult members of a family, but different ads if viewed by children.

The tailoring of secondary content may be positively or negatively implemented. In other words, when teenage children are watching, commercials targeting this age group can be inserted, such as ads for music CDs, video games, or age-appropriate movies. On the other hand, if very young children are viewing a program, the commercials for television shows having violent content can be avoided. This screening ability is expected to encourage user participation in user-profile creation and maintenance.

The user profile is created in any of a number of ways. Information concerning, for example, the age, sex and interests of likely viewers can be collected when service with a particular CATV or Direct TV provider is initiated. Where television programming will be obtained from a broadcast signal, the user-profile information may be programmed into the set itself when it is purchased.

In one embodiment, the user-profile information is stored electronically in the television set remote control (or the remote control associated with a CATV or satellite TV set-top box), or in some other portable input device. In these embodiments, the user profile may be sent to the component that the remote device ordinarily communicates with, whenever the remote device it is used to power up the component. Alternatively, the profile is not sent until the user is determined, either actively or passively, to be present. An interactive graphical display, either on the television or on the input device itself, can be used to update the profile information as desired. In addition, the user turning on the television can be prompted to identify as a particular member of a user-family.

In another embodiment, the user profile may be stored on a mobile internet-access device, such as a cellular phone or personal digital assistant (PDA) (not shown). In our mobile society, viewers may watch from a variety of locations, and, in accordance with this embodiment of the present invention, communicate their user profile to the particular set they happen to be watching. In this way, they can benefit from appropriate selections of secondary content without the need to enter user-profile information each time they go to a new location. This could be accomplished using a universally standard format, or by programming the mobile device to be able to access a variety of different systems and formats. Or the PDA may communicate through a network such as the Internet to initiate a remote-location reporting system. In this instance, of course, the user would have to be able to indicate the particular locations being viewed. A unique location number could be used for this purpose, either entered manually or by swiping a bar-coded identification tag or similar ID device.

The modes of operation described above, of course, require a certain level of user participation, and are therefore termed “active modes”. Although much of the alternate or secondary content will be commercial, it is not unreasonable to believe that users will take an active step to receive advertisements limited to areas that interest them. The incentive for active selection through user-profile use is even stronger where parents of young children have a real interest in filtering the type of material that their children will be exposed to.

Alternately, passive user-profile options are also available. As used herein, passive refers to user identification schemes that require no regular participation. In the most basic mode of operation, mentioned above, information is collected at the time of sale or subscription and use thereafter to determine what adjustment should be made, if any, to the secondary content mode available to the set or service associated with the user.

More sophisticated passive user-profile schemes are also possible. Each of these, in some way, involve a method of predicting with the highest possible accuracy which secondary content is most appropriate for a particular user or users. User profile indicia are collected, stored, and analyzed to make this determination for convenience, each factor that may be useful in making this determination will be referred to as an indicator. A strong indicator (and indicators, of course, can be weighted) is the viewing pattern associated with the viewing location in question. In its most elementary form, for example, the program may simply monitor viewing times. Saturday and Sunday morning viewers may be children, while late-night viewers are more likely to be adults. Weekend afternoons, especially at certain times of the year, may indicate sports-oriented viewing. In a system where data concerning the type of programming viewed, the indicators would prove even more accurate. While sports, children's, and late-night programming providers already take the subject matter itself into account when selecting and targeting advertising, programming type and time are only two of many possible indicators.

Other indicators may involve the type of programming most often viewed by individuals. For example, an indicator may profile in a certain way users who regularly scan (or “surf”) through all of the sports-oriented (or news-oriented) channels before selecting one (or something else) for viewing. Or user behavior during commercials themselves could be monitored. For example, the user may routinely begin scanning for other channels during ads for financial services or for other television shows, but remain tuned to a particular channel when automobiles or electronics products are being advertised. Where a surfing viewer pauses, even for five to ten seconds, during a particular type of advertisement may also prove to be a strong indicator. At a more sophisticated level, the type of ads (e.g., humorous, suggestive, action-packed) most frequently viewed in their entirety may be a strong indicator as well.

External factors may also be taken into account. For example, many modern electronic devices are easily detectable. When, for example, a cellular phone or PDA registers, the fact may be noted and used as yet another indicator. Frequencies used by baby monitors indicate the presence of young children. As wireless devices become more and more common, their use can be taken into account when compiling a “passive” user profile.

User profiles may be useful even where a large number of viewers are gathered. Where profiles can be created, actively or passively, for a single person, group profiles can also be maintained. Families watching television together may constitute a particular demographic that is not strictly speaking the same as if the parents or the children were each watching the same content on their own. Even in an environment such as a sports bar, active and passive profile information can be gathered and cumulatively applied to the secondary content selection process.

The system could also be used to gather consumer-response type information to judge the appeal of certain secondary content, and, within the bounds of privacy considerations, to track or profile the viewing habits of subscribers.

An important aspect of the implementation of this invention is that embodiments of any video processing system, such as digital television system 100, may have control housed internally, such as within a digital receiver, within a set-top box, or distributed among various components. For instance, video processor 220 above, or its substantial equivalent, may be housed in the set-top box, together with a memory that includes software modules executed thereby. In this embodiment, the digital receiver is controlled based on control signals from the set-top box, and will itself include one or more processors, such as the display processor 320 described above, for performing necessary control functions as well as video and audio display functions. Thus, although the invention can be implemented using different controller configurations, for the sake of brevity, the following assumes that the controllers reside in the digital television receiver itself.

Broadly, disclosed are systems for selectively associating cues with stored audio and video frames, and methods of operating the same. According to the foregoing embodiment, digital television system 100 comprises a video recording system and a video playback system. The video recording system is capable of (i) receiving a digital content stream comprising video track data, audio track data and content descriptor data and (ii) storing at least the video track data as video frames in a storage device. The video recording system comprises a commercial detection controller 241 operable, in response to the received content descriptor data, to (i) detect a subset of the video frames associated with a commercial in the received digital content stream, and (ii) associate a cue with at least one of the subset of the video frames. The video playback system is capable of playing back the stored video track data, and comprises a video playback controller 242 operable to detect cues associated with ones of the subsets of the video frames and to direct the video playback system in response thereto to selectively replace the commercial with a substitute commercial during playback.

FIG. 5 illustrates a flow diagram (generally designated 400) of an exemplary method of operating the video processing system, such as digital television system 100, according to the embodiments of FIGS. 1 to 4. For purposes of illustration, concurrent reference is made to these embodiments.

To begin, digital television system 100 conventionally operates (process step 405) to (i) receive digital content streams comprising video track data, audio track data and content descriptor data, (ii) continuously process the received digital content streams in video processor 220 to convert the same to a sequence of synchronized video and audio frames for display, and one of (iiia) display the synchronized frames to display 325 using output buffer 230 as temporary storage, or (iiib) store such synchronized frames in a storage device, such as memory 240, for time-shifted display.

In the event that the synchronized frames are to be stored for time-shifted display, commercial detection controller 241 is operable to detect, in response to processing the received content descriptor data, a subset of video frames associated with a commercial associated with the received digital content stream during the processing thereof (process step 410).

Commercial detection controller 241 is further operable to associate, in response to detecting the subset of video frames, a cue with at least one of the subset of video frames (process step 415). Advantageously, the cue is operable, upon perception by video playback controller 242 during playback, to selectively direct video playback controller 242 to replace the commercial with a substitute commercial. Digital television system 100 then stores the synchronized frames associated with one or more cues in a storage device for time-shifted display, as described hereinabove.

FIG. 6 is a flow diagram illustrating an exemplary method of creating and applying a user profile according to an embodiment of the present invention. The process begins at step 500, where the appropriate hardware and software components have been provided and appropriately interconnected. At step 505, the system then receives user data associated with at least one user profile. As mentioned above, this may actually pertain to a particular person residing at a given location, or it may pertain to a collective group of people whose composite profiles are used in accordance with the system of the present invention. The user data may also be passively gathered. The information may be received in a variety of methods, but in one embodiment (referring to FIGS. 2 and 7), a viewer uses remote control 125 operating through infrared sensors 107 or 160, to initiate a graphical display on screen 106.

Returning to FIG. 6, once the user data has been partially or completely entered, the process continues to step 510 where the user-entered data is compiled into a user profile. Here, the information entered by the user, or passively received, is arranged into a useful format for storage. It should be noted that while a user profile will often correspond to a single individual, this is not necessarily the case. A husband and wife, for example, may have but a single user profile, or data corresponding to a collection of late-night users may be compiled into a single profile. In any event, the compiled user profile is then stored at step 515. Again, the profile data may be stored in a variety of locations including, but not limited to, memory in digital television receiver 105, set top box 150, and remote control 125. Subsequently, the system may receive, actively or passively, modifications to the existing user profile (step 520), at which time the user profile will be recompiled (step 525) and stored (step 515). The dotted lines in FIG. 6 indicate that the user profile-modification process is optional. Once stored, the user profile remains resident on the system, in some fashion, until the system receives an indication that the viewer or viewers associated with a given user profile is viewing the television.

At step 530, the system receives a user ID, that is, some indication that a particular user is now viewing the television. Note that, as mentioned above, the user ID may be received from remote control 125, or alternately, some other input device, either active or passive. For example, a personal digital assistant (PDA), motion or image detector, or cellular telephone, may cause a user ID to be generated and thereby received at step 530. Note that if the user profile itself is stored in a separate component, for example, remote control 125, or PDA (not shown), the user ID received at step 530 may, in fact, be the entire contents of the user profile, or at least a relevant and usable portion thereof. Having now received an indication that a particular user or users are viewing the video display, the system monitors the video stream for embedded cues (step 535). When a secondary content cue is detected (step 540), the system evaluates the user profiles associated with the viewing users and makes a determination whether to substitute alternate secondary content (step 545). This determination can be made using a variety of criteria described throughout this disclosure, but preferably takes into account the user or users viewing at a particular time, and whether the broadcast content stream has been time shifted using a recording device. If for some reason, substitution is not appropriate, the process returns to step 535 and continues to monitor for the next secondary content cue. If substitution is deemed to be appropriate, the process continues to step 550 where the system determines the specific secondary content that should be substituted. Note that there may be only a single choice, for example, a generic commercial can be inserted in place of a time-sensitive commercial such as a Christmas-related advertisement. But there may also be a plurality of choices and, if so, the time and viewing audience may again influence the choice of content. Once the determination of what content to use has been made, the desired secondary content is substituted into the video stream to be viewed by the audience (step 555). Once the substitution has been made, the system again returns to step 535 to monitor the video streams for additional cues. This process continues until the system is in some way deactivated, or until additional user ID or user profile information is received for processing (steps not shown). As mentioned above, the presence of multiple identified users, or various other criteria, as described above, can be used to create a decision-making algorithm to be used at determination steps 545 and 550. These algorithms would preferably be updated as the presence of new viewers or viewer information becomes available to the system. Finally, as an optional step, some form of record-keeping function (step 560) may be performed. For example, the system could return to the broadcast source a report of the secondary content that has been inserted, giving whatever details are desirable including the time of the insertion and characteristics concerning the viewers whose presence factored into the determination of which content to substitute.

Finally, FIG. 7 is an example of a graphically displayed user profile such as one that might be viewed on display 106 (shown in FIG. 2) and that can be used by a viewer to enter or modify user profile information.

Although the present invention has been described in detail, those skilled in the art should understand that they can make various changes, substitutions and alterations herein without departing from the spirit and scope of the invention in its broadest form.

What is claimed is:

1. An interface for use with a broadcast receiver that receives a broadcast stream comprising primary and secondary content, detects cues in the broadcast stream delineating the secondary content, and selectively substitutes alternate secondary content into the broadcast stream based at least in part on the profiles of current users, said interface comprising:
a memory device for storing user-profile information;
a user-identity input device for indicating which users are currently using the receiver; and
a processor in communication with the input device and with the memory device, said processor for associating the current user identity information with the stored user-profile information, wherein the processor controls the selection and substitution of alternate secondary content into the broadcast stream based at least in part on the associated user-profile information.

2. The interface of claim 1, wherein the memory device is integrated into the user-identity input device, and wherein the user-identity indication comprises user-profile information.

3. The interface of claim 1, wherein the user-identity input device is a portable device that can be carried by a user.

4. The interface of claim 3, wherein the user-identity input device is a TV remote control.

5. The interface of claim 3, wherein the user-identity input device is a set-top box remote control.

6. The interface of claim 3, wherein the user-identity input device is a personal digital assistant (PDA).

7. The interface of claim 3, wherein the user-identity input device is a mobile telephone.

8. The interface of claim 1, wherein the memory device is located remotely from the processor and is accessible by the processor through a communications network.

9. The interface of claim 8, wherein the communications network is the Internet.

10. The interface of claim 1, wherein the user-identity input device is a passive device.

11. The interface of claim 1, wherein the user-profile information stored in memory is at least in part passively gathered.

12. A method for selectively substituting alternate secondary content into the primary content stream received in a broadcast receiver, the receiver having a control processor in communication with a memory device, said method comprising the steps of:
storing at least one user profile in the memory device;
identifying a current user of the broadcast receiver;
determining if the identified current user corresponds to a user profile stored the memory device and, if so, determining, based at least in part on the corresponding user profile, whether the available alternate secondary content should be substituted into the content stream; and
executing, in the control processor, a control routine to direct the receiver to substitute the alternate secondary content into the content stream, if it is determined that the substitution should be performed.

13. The method of claim 12, wherein the user-profile information stored in memory is at least in part passively gathered.

14. The method of claim 12, wherein the current user identifying step is performed passively.

15. The method of claim 12, wherein the broadcast content stream includes cues indicating where in the broadcast stream the secondary content is located and further comprising the step of, prior to the determining step, detecting a secondary-content cue in the content stream.

16. The method of claim 15, wherein the secondary-content cue comprises date-related information, and wherein the determination of whether alternate secondary content should be substituted is based at least in part on the date-related information.

17. The method of claim 12, wherein the broadcast content comprises video programming.

18. The method of claim 17, wherein the broadcast receiver is in communication with a video recording and playback device, and further comprising the step of performing the identifying, determining, and executing steps during the playback of a recorded video content stream.

19. The method of claim 12, further comprising the step of automatically prompting a user for user-profile information if it is determined that an identified user is not associated with a user-profile stored in the memory device.

20. The method of claim 12, wherein the memory device is resident in a remote control device.

21. The method of claim 12, wherein the memory device is resident in a personal digital assistant (PDA).
